(19) United States
(12) Patent Application Publication
(10) Pub. No.: US 2022/0165483 A1
(43) Pub. Date: May 26, 2022

(54) INDUCTOR

(71) Applicant: NITTO DENKO CORPORATION, Osaka (JP)

(72) Inventors: Keisuke OKUMURA, Osaka (JP); Yoshihiro FURUKAWA, Osaka (JP)

(73) Assignee: NITTO DENKO CORPORATION, Osaka (JP)

(21) Appl. No.: 17/437,673

(22) PCT Filed: Feb. 5, 2020
(86) PCT No.: PCT/JP2020/004238

§ 371 Date: Sep. 9, 2021

(30) Foreign Application Priority Data
Mar. 12, 2019 (JP) 2019-044779

(51) Int. Cl. H01F 27/28; H01F 27/255

(52) U.S. Cl. CPC H01F 27/2866; H01F 27/255

(57) ABSTRACT

An inductor includes a wire including a conducting line, and an insulating film disposed on an entire circumferential surface of the conducting line, and a magnetic layer embedding the wire. The magnetic layer contains a magnetic particle. The magnetic layer includes a first layer in contact with a first surface of an outer peripheral surface of the wire, and a second layer in contact with a second surface of the outer peripheral surface of the wire and the surface of the first layer. The relative magnetic permeability of the first layer is higher than the relative magnetic permeability of the second layer.

### TECHNICAL FIELD

The present invention relates to an inductor.

### BACKGROUND ART

Conventionally, it has been known that an inductor is loaded on an electronic device and the like to be used as a passive element for a voltage conversion member and the like.

For example, an inductor including a rectangular parallelepiped chip body portion made of a magnetic material, and an inner conductor made of copper embedded in the interior of the chip body portion has been proposed (ref: For example, Patent Document 1 below).

### CITATION LIST

### Patent Document

Patent Document 1: Japanese Unexamined Patent Publication No. H10-144526

### SUMMARY OF THE INVENTION

### Problem to be Solved by the Invention

However, in the inductor of Patent Document 1, there is a problem that the DC superposition characteristics are insufficient.

The present invention provides an inductor having excellent DC superposition characteristics.

### Means for Solving the Problem

The present invention (1) includes an inductor including a wire including a conducting line, and an insulating film disposed on an entire circumferential surface of the conducting line, and a magnetic layer embedding the wire, wherein the magnetic layer contains a magnetic particle, and includes a first layer in contact with a portion of the circumferential surface of the wire, and a second layer in contact with the rest of the circumferential surface of the wire and the surface of the first layer, and the relative magnetic permeability of the first layer is higher than the relative magnetic permeability of the second layer.

The present invention (2) includes the inductor described in (1), wherein the magnetic particle contained in the first layer has a generally flat shape, and the magnetic particle contained in the second layer has a generally spherical shape.

The present invention (3) includes the inductor described in (1) or (2), wherein the contact area S1 of the first layer with respect to the circumferential surface of the wire is larger than the contact area S2 of the second layer with respect to the circumferential surface of the wire.

The present invention (4) includes the inductor described in (3), wherein a ratio (S2/(S1+S2)) of the contact area S2 of the second layer to the total sum of the contact area S1 of the first layer find the contact area S2 of the second layer is 0.1 or more, and 0.3 or less.

The present invention (5) includes the inductor described in any one of (1) to (4), wherein the first layer has a generally arc shape in a cross-sectional view sharing the center of gravity with the wire, and the second layer has a flat surface.

The present invention (6) includes the inductor described in any one of (1) to (5), wherein the first layer has an extending portion extending from the wire in a direction perpendicular to an extending direction of the wire and a thickness direction of the magnetic layer.

### Effect of the Invention

The inductor of the present invention has excellent DC superposition characteristics.

### BRIEF DESCRIPTION OF THE DRAWINGS

FIG. 1 shows a front cross-sectional view of one embodiment of an inductor of the present invention.

FIGS. 2A to 2D show views for illustrating a method for producing the inductor shown in FIG. 1:

FIG. 2A illustrating a step of preparing a wire and a first sheet,

FIG. 2B illustrating a step of thermally pressing the first sheet to the wire,

FIG. 2C illustrating a step of peeling a release sheet and disposing a second sheet, and

FIG. 2D illustrating a step of thermally pressing the second sheet to the wire.

FIG. 3 shows a front cross-sectional view of a modified example (embodiment in which a first layer does not include an extending portion) of the inductor shown in FIG. 1.

FIG. 4 shows a front cross-sectional view of a modified example (embodiment in which a second layer does not have a one-side second layer) of the inductor shown in FIG. 1.

### DESCRIPTION OF EMBODIMENTS

### One Embodiment

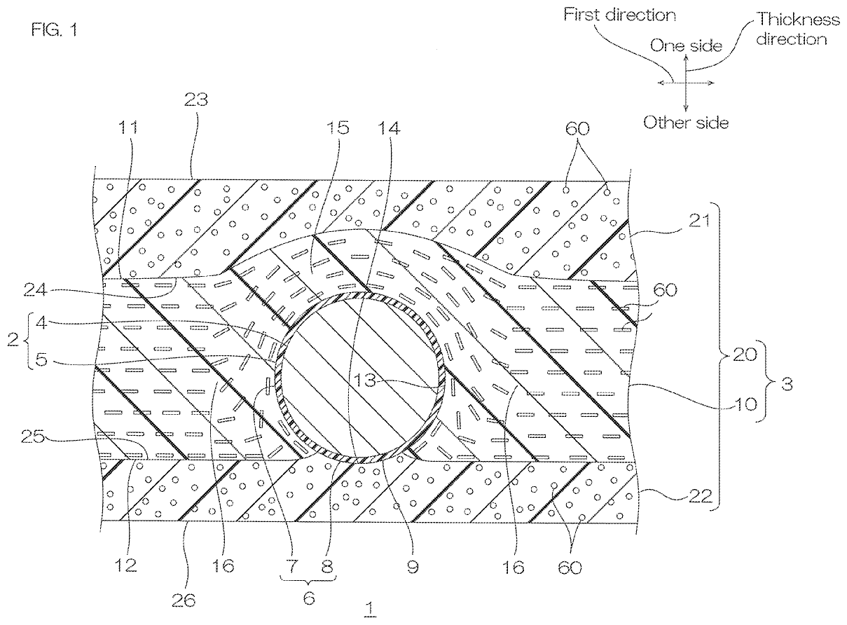

One embodiment of an inductor of the present invention is described with reference to FIG. 1.

In FIG. 1, in order to easily understand one embodiment, a shape, orientation, and the like of a magnetic particle 60 (described later) are exaggeratedly drawn.

As shown in FIG. 1, an inductor 1 has a shape extending in a plane direction. Specifically, the inductor 1 has one surface and the other surface facing each other in a thickness direction, both one surface and the other surface have a flat shape along a first direction perpendicular to a direction which is included in the plane direction and in which a wire 2 (described later) transmits an electric current (corresponding to the depth direction on the plane of the sheet) and the thickness direction.

The inductor 1 includes the wire 2 and a magnetic layer 3.

### Wire

The wire 2 has a generally circular shape in a cross-sectional view. Specifically, the wire 2 has, for example, a generally circular shape when cut in a cross-section (cross-section in the first direction) perpendicular to a second direction (transmission direction) (depth direction on the plane of the sheet) which is a direction for transmitting the electric current.

The wire 2 includes a conducting line 4, and an insulating film 5 covering it.

The conducting line 4 is a conducting line having a shape extending long in the second direction. Further, the conducting line 4 has a generally circular shape in a cross-sectional view sharing the center of gravity (central axis) with the wire 2.

Examples of a material for the conducting line 4 include metal conductors such as copper, silver, gold, aluminum, nickel, and an alloy of these, and preferably, copper is used. The conducting line 4 may have a single-layer structure, or a multi-layer structure in which plating (for example, nickel) is applied to the surface of a core conductor (for example, copper).

A radius of the conducting line 4 is, for example, 25 μm or more, preferably 50 μm or more, and for example, 2000 μm or less, preferably 200 μm or less.

The insulating film 5 protects the conducting line 4 from chemicals and water, and also prevents a short circuit of the conducting line 4 with the magnetic layer 3. The insulating film 5 covers the entire outer peripheral surface (circumferential surface) of the conducting line 4. The insulating film 5 is disposed on the entire outer peripheral surface of the conducting line 4. The outer peripheral surface of the insulating film 5 forms an outer peripheral surface 6 (described later) of the wire 2. The insulating film 5 has a generally circular ring shape in a cross-sectional view sharing the center of gravity (central axis) (center) with the wire 2.

Examples of a material for the insulating film 5 include insulating resins such as polyvinyl formal, polyester, polyesterimide, polyamide (including nylon), polyimide, polyamideimide, and polyurethane. These may be used alone or in combination of two or more.

The insulating film 5 may consist of a single layer or a plurality of layers.

A thickness of the insulating film 5 is generally uniform in a radial direction of the wire 2 at any position in a circumferential direction, and is, for example, 1 μm or more, preferably 3 μm or more, and for example, 100 μm or less, preferably 50 μm or less.

A ratio of a radius of the conducting line 4 to the thickness of the insulating film 5 is, for example, 1 or more, preferably 5 or more, and for example, 500 or less, preferably 100 or less.

A radius R (=the total sum of the radius of the conducting line 4 and the thickness of the insulating film 5) of the wire 2 is, for example, 25 μm or more, preferably 50μm or more, and for example, 2000 μm or less, preferably 200 μm or less.

### Outline of Magnetic Layer (Layer Configuration, Shape, etc.)

The magnetic layer 3 improves the DC superposition characteristics of the inductor 1, while improving the inductance of the inductor 1. The magnetic layer 3 is in contact with the entire outer peripheral surface (circumferential surface) 6 of the wire 2, and covers it. Thus, the magnetic layer 3 embeds the wire 2. The magnetic layer 3 forms the outer shape of the inductor 1. Specifically, the magnetic layer 3 has a rectangular shape extending in the plane direction (the first direction and the second direction). More specifically, the magnetic layer 3 has one surface and the other surface facing each other in the thickness direction, and one surface and the other surface of the magnetic layer 3 form one surface and the other surface of the inductor 1, respectively.

The magnetic layer 3 includes a first layer 10 and a second layer 20. Preferably, the magnetic layer 3 consists of the first layer 10 and the second layer 20.

The first layer 10 has a shape extending in the plane direction. The first layer 10 is an intermediate layer in the magnetic layer 3. The first layer 10, together with the second layer 20, is in contact with the outer peripheral surface 6 of the wire 2.

Specifically, the first layer 10 is in contact with a first surface 7 included in the outer peripheral surface 6 of the wire 2.

The first surface 7 constitutes a main surface (one example of a portion) in the outer peripheral surface 6 of the wire 2 in a cross-sectional view, and specifically, is an arc surface in which a central angle is above 180 degrees in the outer peripheral surface 6 in a cross-sectional view. The central angle of the first surface 7 is preferably 210 degrees or more, more preferably 225 degrees or more, and preferably 330 degrees or less, more preferably 315 degrees or less.

The area of the first surface 7 corresponds to the contact area S1 of the first layer 10 with respect to the outer peripheral surface 6 of the wire 2. The contact area S1, together with the contact area S2 to be described later, is described later.

The first layer 10 has one surface 11, an other surface 12, and a first contact surface 13.

The one surface 11 is provided for each inductor 1. The one surface 11 is a generally flat surface.

The live other surface 12 is oppositely disposed at the other side in the thickness direction with respect to the one surface 11. The two other surfaces 12 are provided for each wire 2. The two other surfaces 12 are disposed at spaced intervals to each other in the first direction. The other surface 12 is a generally flat surface. Each inner end edge of the two other surfaces 12 is located on the outer peripheral surface of the wire 2.

The first contact surface 13 is oppositely disposed in the thickness direction with respect to the one surface 11. The first contact surface 13 has a generally arc shape in a cross-sectional view. The first contact surface 13 connects the inner end edges of the two other surfaces 12. Further, the first contact surface 13 is in contact with the first surface 7 of the wire 2. The first layer 10 embeds a thickness directional other end portion 9 of the wire 2 so as to expose toward the other side in the thickness direction by bringing the first contact surface 13 into contact with the first surface 7.

The first layer 10 integrally has an arc portion 15 and an extending portion 16 in a cross-sectional view.

The arc portion 15 is disposed at one side in the thickness direction from the center of the wire 2. The arc portion 15 has an arc shape sharing the center with the wire 2. The arc portion 15 faces an area at one side in the thickness direction from the center of the wire 2 in the radial direction on the circumferential surface of the wire 2 in a cross-sectional view. The arc portion 15 is partitioned by the corresponding one surface 11 and the corresponding first contact surface 13.

The extending portion 16 has a shape extending outwardly in the first direction from the wire 2. The two extending portions 16 are provided in the first layer 10. Each of the two extending portions 16 is disposed at each of both outer sides in the first direction of the wire 2. Each of the two extending portions 16 extends outwardly in the first direction from a region facing the wire 2 in the first direction on the outer peripheral surface 6 of the wire 2 to reach each of both end surfaces in the first direction of the inductor 1. The extending portion 16 is partitioned by the facing first contact surface 13, the corresponding one surface 11, and the corresponding other surface 12. The one surface 11 and the other surface 12 in the extending portion 16 are parallel. The extending portion 16 has two flat belt shapes extending in the second direction at both outer sides in the first direction of the wire 2 when viewed from the top.

A thickness of the arc portion 15 is, for example, 1 μm or more, preferably 5 μm or more, and for example, 1000 μm or less, from the viewpoint of ensuring further more excellent DC superposition characteristics, preferably 800 μm or less, more preferably 600 μm or less, further more preferably 400 μm or less, particularly preferably 200 μm or less, most preferably 130 μm or less. A ratio of the thickness of the arc portion 15 to the thickness (described later) of the magnetic layer 3 is, for example, 0.01 or more, preferably 0.1 or more, and for example, 0.5 or less, from the viewpoint of ensuring further more excellent DC superposition characteristics, preferably 0.4 or less, more preferably 0.3 or less, further more preferably 0.25 or less, particularly preferably 0.2 or less.

A thickness of the extending portion 16 is, for example, 2 μm or more, preferably 10 μm or more, and for example, 2000 μm or less, preferably 1600 μm or less. A ratio of the thickness of the extending portion 16 to the thickness (described later) of the magnetic layer 3 is, for example, 0.1 or more, preferably 0.2 or more, and for example, 0.7 or less, preferably 0.5 or less.

The thickness of the first layer 10 is a distance (specifically, corresponding to the thickness of the arc portion 15) between the one surface 11 and the other surface 12 of the first layer 10 at a one-side portion (immediate upper portion) in the thickness direction with respect to a midpoint (center when the wire 2 has a circular shape in a cross-sectional view) of the maximum length in the first direction of the wire 2. Further, the thickness of the first layer 10 is also a distance between the one surface 11 and the other surface 12 of the first layer 10 at the one-side portion (immediate upper portion) in the thickness direction with respect to the center of gravity of the wire 2 in a cross-sectional view. When both the midpoint and the center of gravity described above are determined, the definition of the thickness of the first layer 10 based on the midpoint is preferentially adopted. On the other hand, when only the center of gravity is determined, the definition of the thickness of the first layer 10 based on the center of gravity is adopted.

The second layer 20 is in contact with a second surface 8 (described later) of the outer peripheral surface of the wire 2, and the one surface 11 and the other surface 12 in the thickness direction as one example of the surface of the first layer 10. The second layer 20 is a surface layer in the magnetic layer 3.

The second layer 20 independently has a one-side second layer 21 and an other-side second layer 22. Preferably, the second layer consists of the one-side second layer 21 and the other-side second layer 22.

The one-side second layer 21 is disposed at one side in the thickness direction of the first layer 10. Specifically, the one-side second layer 21 is in contact with the one surface 11 of the first layer 10. The one-side second layer 21 has a shape extending in the plane direction. The one-side second layer 21 has an other surface 24 in contact with the one surface 11 of the first layer 10, and one surface 23 which is disposed at one side in the thickness direction of the other surface 24 at spaced intervals thereto. The one surface 23 of the one-side second layer 21 has a flat shape. That is, the one surface 23 is a flat surface. The one surface 23 of the one-side second layer 21 forms one surface in the thickness direction of the inductor 1. The other surface 24 of the one-side second layer 21 is a generally flat surface, and more specifically, has a shape following the one surface 11 in the arc portion 15 find the two extending portions 16 of the first layer 10.

The other-side second layer 22 is disposed at the other side in the thickness direction of the wire 2 and the first layer 10. The other-side second layer 22 has a shape extending in the plane direction. The other-side second layer 22 is in contact with the second surface 8 included in the outer peripheral surface 6 of the wire 2 and the other surface 12 of the first layer 10.

The second surface 8 is the rest of the first surface 7 in the outer peripheral surface 6 of the wire 2 in a cross-sectional view, and is an arc surface in which a central angle is below 180 degrees in the outer peripheral surface 6 of the wire 2 in a cross-sectional view. The central angle of the second surface 8 is preferably 45 degrees or more, more preferably 60 degrees or more, and preferably 150 degrees or less, more preferably 135 degrees or less.

The area of the second surface 8 corresponds to the contact area S2 of the second layer 20 (the other-side second layer 22) with respect to the outer peripheral surface 6 of the wire 2.

The contact area S2 of the second layer 20 with respect to the outer peripheral surface 6 (the second surface 8) of the wire 2 is preferably smaller than the contact area S1 of the first layer 10 with respect to the outer peripheral surface 6 (the first surface 7) of the wire 2. In other words, the contact area S1 of the first layer 10 with respect to the outer peripheral surface 6 (the first surface 7) of the wire 2 is preferably larger than the contact area S2 of the second layer 20 with respect to the outer peripheral surface 6 (the second surface 8) of the wire 2. That is, the area S1 of the first surface 7 is preferably larger than the area S2 of the second surface 8.

A ratio (S2/(S1+S2)) of the contact area S2 of the second layer 20 with respect to the outer peripheral surface 6 of the wire 2 to the total sum of the contact area S1 of the first layer 10 with respect to the outer peripheral surface 6 of the wire 2 and the contact area S2 of the second layer 20 with respect to the outer peripheral surface 6 of the wire 2 is, for example, 0.01 or more, preferably 0.1 or more, and for example, below 0.5, preferably 0.4 or less, more preferably 0.3 or less. When the ratio of the contact area S2 is within the above-described range, it is possible to suppress the magnetic saturation of a magnetic body (the magnetic layer 3) at the time of large current application, and thus, it is possible to further improve the DC superposition characteristics of the inductor 1.

The other-side second layer 22 has one surface 25 in contact with tire second surface 8 of the wire 2 and the other surfaces 12 of the two extending portions 16, and an other surface 26 disposed at the other side in the thickness direction of the one surface 25 at spaced intervals thereto.

The one surface 25 of the other-side second layer 22 is a generally flat surface, and specifically, has a shape following the second surface 8 of the wire 2 and the other surfaces 12 of and the two extending portions 16. The one surface 25 of the other-side second layer 22 includes a second contact surface 14 in contact with the second surface 8 of the wire 2.

The other surface 26 of the other-side second layer 22 has a flat shape. That is, the other surface 26 is a flat surface. The other surface 26 of the other-side second layer 22 forms the other surface in the thickness direction of the inductor 1.

The thickness of the second layer 20 is the total thickness of the one-side second layer 21 and the other-side second layer 22, and is, for example, 2 μm or more, preferably 10 μm or more, and for example, 2000 μm or less, preferably 1600 μm or less.

The thickness of the one-side second layer 21 is a distance between the one surface 23 and the other surface 24 of the one-side second layer 21 at the one-side portion (immediate upper portion) in the thickness direction with respect to the midpoint (center when the wire 2 has a circular shape in a cross-sectional view) of the maximum length in the first direction of the wire 2. Further, the thickness of the one-side second layer 21 is also a distance between the one surface 23 and the other surface 24 of the one-side second layer 21 at the one-side portion (immediate upper portion) in the thickness direction with respect to the center of gravity of the wire 2 in a cross-sectional view. When both the midpoint and the center of gravity described above are determined, the definition of the thickness of the one-side second layer 21 based on the midpoint is preferentially adopted. On the other hand, when only the center of gravity is determined, the definition of the thickness of the one-side second layer 21 based on the center of gravity is adopted.

The thickness of the other-side second layer 22 is a distance between the one surface 25 and the other surface 26 of the other-side second layer 22 at the other-side portion (immediate lower portion) in the thickness direction with respect to the midpoint (center when the wire 2 has a circular shape in a cross-sectional view) of the maximum length in the first direction of the wire 2. Further, the thickness of the other-side second layer 22 is also a distance between the one surface 25 and the other surface 26 of the other-side second layer 22 at the other-side portion (immediate lower portion) in the thickness direction with respect to the center of gravity of the wire 2 in a cross-sectional view. When both the midpoint and the center of gravity described above are determined, the definition of the thickness of the other-side second layer 22 based on the midpoint is preferentially adopted. On the other hand, when only the center of gravity is determined, the definition of the thickness of the other-side second layer 22 based on the center of gravity is adopted.

Further, the thickness of the one-side second layer 21 is, for example, 1 μm or more, preferably 5 μm or more, and for example, 1000 μm or less, preferably 800 μm or less. The thickness of the other-side second layer 22 is, for example, 1 μm or more, preferably 5 μm or more, and for example, 1000 μm or less, preferably 800 μm or less. A ratio of the thickness of the one-side second layer 21 to the thickness of the other-side second layer 22 is, for example, 2 or less, preferably 1.5 or less, and for example, 0.1 or more, preferably 0.3 or more. When the ratio of the thickness of the one-side second layer 21 is the above-described upper limit or less and the above-described lower limit or more, it is possible to obtain further more excellent DC superposition characteristics.

A ratio of the thickness of the second layer 20 to the thickness (described later) of the magnetic layer 3 is, for example, 0.1 or more, preferably 0.2 or more, and for example, 0.7 or less, preferably 0.5 or less.

The thickness of the magnetic layer 3 is the total thickness of the first layer 10 and the second layer 20 in a region deviated from the wire 2 in a projected surface projected in the thickness direction, and is, for example, 2 times or more, preferably 3 times or more, and for example, 20 times or less the radius of the wire 2. Specifically, the thickness of the magnetic layer 3 is, for example, 100 μm or more, preferably 200 μm or more, and for example, 3000 μm or less, preferably 1500 μm or less. The thickness of the magnetic layer 3 is a distance between one surface (the one surface 23 of the one-side second layer 21) and the other surface (the other surface 26 of the other-side second layer 22) of the magnetic layer 3.

### Material for Magnetic Layer

The magnetic layer 3 contains the magnetic particles 60. Specifically, an example of a material for the magnetic layer 3 includes a magnetic composition containing the magnetic particles 60 and a binder.

Examples of a magnetic material constituting the magnetic particles 60 include a soft magnetic body and a hard magnetic body. Preferably, from the viewpoint of inductance and DC superposition characteristics, a soft magnetic body is used.

Examples of the soft magnetic body include a single metal body containing one kind of metal element in a state of a pure material and an alloy body which is a eutectic (mixture) of one or more kinds of metal element (first metal element) and one or more kinds of metal element (second metal element) and/or non-metal element (carbon, nitrogen, silicon, phosphorus, and the like). These may be used alone or in combination.

An example of the single metal body includes a metal single body consisting of only one kind of metal element (first metal element). The first metal element is, for example, appropriately selected from metal elements that can be included as the first metal element of the soft magnetic body such as iron (Fe), cobalt (Co), nickel (Ni), and the like.

Further, examples of the single metal body include an embodiment including a core including only one kind of metal element and a surface layer including an inorganic material and/or an organic material which modify/modifies a portion of or the entire surface of the core, and an embodiment in which an organic metal compound and an inorganic metal compound including the first metal element are decomposed (thermally decomposed and the like). More specifically, an example of the latter embodiment includes an iron powder (may be referred to as a carbonyl iron powder) in which an organic iron compound (specifically, carbonyl iron) including iron as the first metal element is thermally decomposed. The position of a layer including the inorganic material and/or the organic material modifying a portion including only one kind of metal element is not limited to the above-described surface. The organic metal compound and the inorganic metal compound that can obtain the single metal body are not particularly limited, and can be appropriately selected from a known or conventional organic metal compound and inorganic metal compound that can obtain the single metal body of the soft magnetic body.

The alloy body is not particularly limited as long as it is a eutectic of one or more kinds of metal element (first metal element) and one or more kinds of metal element (second metal element) and/or non-metal element (carbon, nitrogen, silicon, phosphorus, and the like), and can be used as an alloy body of a soft magnetic body.

The first metal element is an essential element in the alloy body, and examples thereof include iron (Fe), cobalt (Co), and nickel (Ni). When the first metal element is Fe, the alloy body is referred to as an Fe-based alloy; when the first metal element is Co, the alloy body is referred to as a Co-based alloy; and when the first metal element is Ni, the alloy body is referred to as a Ni-based alloy.

The second metal element is an element (sub-component) which is secondarily contained in the alloy body, and is a metal element to be compatible with (eutectic to) the first metal element. Examples thereof include iron (Fe) (when the first metal element is other than Fe), cobalt (Co) (when the first metal element is other than Co), nickel (Ni) (when the first metal element is other than Ni), chromium (Cr), aluminum (Al), silicon (Si), copper (Cu), silver (Ag), manganese (Mn), calcium (Ca), barium (Ba), titanium (Ti), zirconium (Zr), hafnium (Hf), vanadium (V), niobium (Nb), tantalum (Ta), molybdenum (Mo), tungsten (W), ruthenium (Ru), rhodium (Rh), zinc (Zn), gallium (Ga), indium (In), germanium (Ge), tin (Sn), lead (Pb), scandium (Sc), yttrium (Y), strontium (Sr), and various rare earth elements. These may be used alone or in combination of two or more.

The non-metal element is an element (sub-component) which is secondarily contained in the alloy body and is a non-metal element which is compatible with (eutectic to) the first metal element. Examples thereof include boron (B), carbon (C), nitrogen (N), silicon (Si), phosphorus (P), and sulfur (S). These may be used alone or in combination of two or more.

Examples of the Fe-based alloy which is one example of an alloy body include magnetic stainless steel (Fe—Cr—Al—Si alloy) (including electromagnetic stainless steel). Sendust (Fe—Si—Al alloy) (including Supersendust), permalloy (Fe—Ni alloy), Fe—Ni—Mo alloy, Fe—Ni—Mo—Cu alloy, Fe—Ni—Co alloy, Fe—Cr alloy, Fe—Cr—Al alloy, Fe—Ni—Cr alloy, Fe—Ni—Cr—Si alloy, silicon copper (Fe—Cu—Si alloy), Fe—Si alloy, Fe—Si—B (—Cu—Nb) alloy, Fe—B—Si—Cr alloy, Fe—Si—Cr—Ni alloy, Fe—Si—Cr alloy, Fe—Si—Al—Ni—Cr alloy, Fe—Ni—Si—Co alloy, Fe—N alloy, Fe—C alloy, Fe—B alloy, Fe—P alloy, ferrite (including stainless steel ferrite and further, soft ferrite such as Mn—Mg ferrite, Mn—Zn ferrite. Ni—Zn ferrite, Ni—Zn—Cu ferrite, Cu—Zn ferrite, and Cu—Mg—Zn ferrite), Permendur (Fe—Co alloy), Fe—Co—V alloy, and Fe-based amorphous alloy.

Examples of the Co-based alloy which is one example of an alloy body include Co—Ta—Zr and a cobalt (Co)-based amorphous alloy.

An example of the Ni-based alloy which is one example of an alloy body includes a Ni—Cr alloy.

Preferably, the magnetic material is appropriately selected from these soft magnetic bodies so that each of the first layer 10 and the second layer 20 satisfies the desired relative magnetic permeability (described later).

Preferably, the first layer 10 contains an Fe-based alloy, and the second layer 20 contains an iron powder in which the organic iron compound is thermally decomposed. More preferably, the first layer 10 contains Sendust and the second layer 20 contains a carbonyl iron powder.

A shape of the magnetic particles 60 is not particularly limited, and examples thereof include a shape showing anisotropy such as a generally flat shape (plate shape) and a generally needle shape (including a generally spindle (football) shape), and a shape showing isotropy such as a generally spherical shape, a generally granular shape, and a generally massive shape. The shape of the magnetic particles 60 is appropriately selected from the description above so that each of the first layer 10 and the second layer 20 satisfies the desired relative magnetic permeability.

Preferably, the magnetic particles 60 contained in the first layer 10 have a shape showing anisotropy, and the magnetic particles 60 contained in the second layer 20 have a shape showing isotropy.

More preferably, the magnetic particles 60 contained in the first layer 10 have a generally flat shape, and the magnetic particles 60 contained in the second layer 20 have a generally spherical shape. According to this, it is possible to suppress the magnetic saturation of the magnetic body (the magnetic layer 3) at the time of large current application, and thus, it is possible to further improve the DC superposition characteristics of the inductor 1.

When the magnetic particles 60 contained in the first layer 10 have a shape (specifically, a generally flat shape) having anisotropy, the magnetic particles 60 are orientated in the circumferential direction of the wire 2 in the arc portion 15, and a region located in the vicinity of the wire 2 in the extending portion 16 (for example, a region extending outwardly in the radial direction from the first surface 7 of the wire 2 by the same distance (preferably, a half value of the thickness of the arc portion 15) as the thickness of the arc portion 15). A case where an angle formed with a tangent in contact with the first surface 7 of the wire 2 is 15 degrees or less is defined that the magnetic particles 60 are orientated in the circumferential direction.

On the other hand, the magnetic particles 60 contained in the first layer 10 are orientated in the plane direction in a region located remotely from the wire 2 in the extending portion 16 (for example, a region exceeding the same distance as the thickness from the first surface 7 of the wire 2 to the arc portion 15).

On the other hand, when the magnetic particles 60 contained in the second layer 20 have a shape showing isotropy (specifically, a generally spherical shape), the magnetic particles 60 are not orientated, and uniformly (isotropically) dispersed.

An average value of the maximum length of the magnetic particles 60 is, for example, 0.1 μm or more, preferably 0.5 μm or more, and for example, 200 μm or less, preferably 150 μm or less. The average value of the maximum length of the magnetic particles 60 can be calculated as a neutral particle size of the magnetic particles 60.

The average value of the maximum length of the magnetic particles 60 showing anisotropy is, for example, 3 μm or more, preferably 5 μm or more, and for example, 200 μm or less, preferably 150 μm or less.

An average particle size of the magnetic particles 60 showing isotropy is, for example, 0.1 μm or more, preferably 0.5 μm or more, and for example, 100 μm or less, preferably 50 μm or less.

A volume ratio (filling ratio) of the magnetic particles 60 in the magnetic composition is, for example, 10% by volume or more, preferably 20% by volume or more, and for example, 90% by volume or less, preferably 80% by volume or less.

By appropriately changing the kind, the shape, the size, the volume ratio, and the like of the magnetic particles 60, the relative magnetic permeability of the first layer 10 and the second layer 20 satisfies a desired relationship.

Examples of the binder include thermoplastic components such as an acrylic resin and thermosetting components such as an epoxy resin composition. The acrylic resin contains, for example, a carboxyl group-containing acrylic acid ester copolymer. The epoxy resin composition contains, for example, an epoxy resin (cresol novolak-type epoxy resin and the like) as a main agent, a curing agent for an epoxy resin (phenol resin and the like), and a curing accelerator for an epoxy resin (imidazole compound and the like).

As the binder, a thermoplastic component and a thermosetting component may be used alone or in combination, and preferably, a thermoplastic component and a thermosetting component are used in combination.

A more detailed formulation of the magnetic composition described above is described in Japanese Unexamined Patent Publication No. 2014-165363 and the like.

### Relative Magnetic Permeability of Magnetic Layer

The relative magnetic permeability of the first layer 10 is higher than that of the second layer 20.

The relative magnetic permeability of both the first layer 10 and the second layer 20 is measured at a frequency of 10 MHz.

A ratio R (relative magnetic permeability of the first layer 10/relative magnetic permeability of the second layer 20) of the relative magnetic permeability of the first layer 10 to the relative magnetic permeability of the second layer 20 is, for example, 1.1 or more, preferably 1.5 or more, more preferably 2 or more, further more preferably 5 or more, particularly preferably 10 or more, most preferably 15 or more, and for example, 10000 or less, for example, 1000 or less.

A value D (relative magnetic permeability of the first layer 10—relative magnetic permeability of the second layer 20) obtained by subtracting the relative magnetic permeability of the second layer 20 from the relative magnetic permeability of the first layer 10 is, for example, 1 or more, preferably 5 or more, more preferably 10 or more, further more preferably 25 or more, particularly preferably 100 or more, most preferably 125 or more, and for example, 1000 or less.

When the ratio R and the difference D (subtracted value) of the relative magnetic permeability described above are the above-described lower limit or more, it is possible to more efficiently improve the DC superposition characteristics of the inductor 1.

Further, each layer is defined by the relative magnetic permeability of each layer described above.

Specifically, the relative magnetic permeability of one surface of the magnetic layer 3, that is, the one surface 23 of the one-side second layer 21 is measured to be subsequently continuously measured so as to go toward the other side in the thickness direction, and a region having the same relative magnetic permeability as that first obtained is defined as the one-side second layer 21.

On the other hand, the relative magnetic permeability of the other surface of the magnetic layer 3, that is, the other surface 26 of the other-side second layer 21 is measured to be subsequently continuously measured so as to go toward one side in the thickness direction, and a region having the same relative magnetic permeability as that first obtained is defined as the other-side second layer 22.

Thereafter, in the magnetic laser 3, in a region in which the wire 2 is deviated in the projected surface projected in the thickness direction, a region sandwiched between the one-side second layer 21 and the other-side second layer 22 in the thickness direction is defined as the first layer 10.

In the description above, the measurement of the relative magnetic permeability is carried out from one surface and the other surface 3 of the magnetic layer 3. Alternatively, for example, it can be also carried out from the first contact surface 13 of the first layer 10.

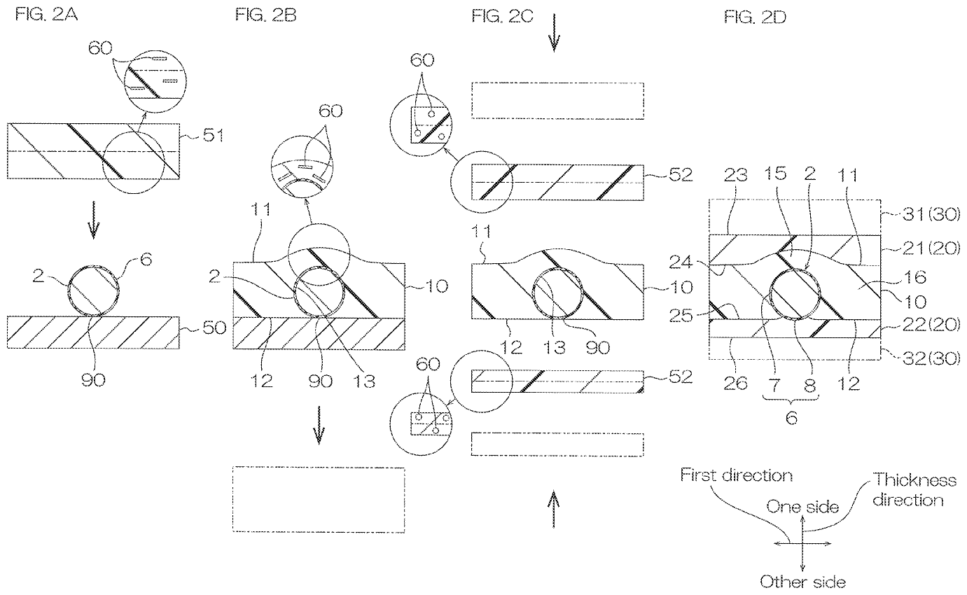

As described later, when each layer is formed of a plurality of magnetic sheets (described later) (ref: phantom line of FIG. 2), in view of the definition described above, the relative magnetic permeability of the plurality of magnetic sheets for forming each layer is substantially the same.

Further, in a producing method to be described later, the relative magnetic permeability of a first sheet 51 and a second sheet 52 for forming the magnetic layer 3 can be measured in advance to be defined as the relative magnetic permeability of the first layer 10 and the second layer 20, respectively.

### Producing Method of Inductor

A method for producing the inductor 1 is described with reference to FIGS. 2A to 2D.

In FIGS. 2A to 2D, except for a separate frame view, the magnetic particles 60 are omitted in order to clearly show the relative arrangement of the wire 2 and the magnetic layer 3.

To produce the inductor 1, first, the wire 2 is prepared.

For example, the wire 2 is disposed on one surface in the thickness direction of a release sheet 50. Specifically, the release sheet 50 has hard and flat one surface. Further, one surface of the release sheet 50 may be subjected to appropriate release treatment.

Subsequently, the one first sheet 51 and the two second sheets 52 are prepared. The first sheet 51 and the second sheet 52 are magnetic sheets (magnetic layer sheets) for forming the first layer 10 and the second layer 20, respectively.

The relative magnetic permeability of the first sheet 51 is the same as that of the first layer 10. The relative magnetic permeability of the second sheet 52 is the same as that of the second layer 20. Therefore, the relative magnetic permeability of the first sheet 51 is higher than that of the second sheet 52. Specifically, the formulation (specifically, the kind, the shape, the volume ratio, and the like of the magnetic particles 60) of the magnetic composition contained in the first sheet 51 and the second sheet 52 is appropriately adjusted (changed) so that the relative magnetic permeability of the first sheet 51 is higher than that of the second sheet 52. Each of the first sheet 51 and the second sheet 52 is formed into a sheet (plate) shape extending in the plane direction from the magnetic composition described above.

Further, preferably, the first sheet 51 contains the magnetic particles 60 having a shape showing anisotropy, and the second sheet 52 contains the magnetic particles 60 having a shape showing isotropy.

More preferably, the first sheet 51 contains the magnetic particles 60 having a generally flat shape, and the second sheet 52 contains the magnetic particles 60 having a generally spherical shape.

The first sheet 51 may be a single layer, or as referred to the phantom line of FIG. 2A, may consist of a plurality of layers (two or more layers) in accordance with the application and purpose.

Also, each of the two second sheets 52 may be a single layer, or as referred to the phantom line of FIG. 2C, may consist of a plurality of layers (two or more layers).

When the first sheet 51 contains the magnetic particles 60 having a shape having anisotropy (specifically, a generally flat shape), as shown by the separate frame view of FIG. 2A, the magnetic particles 60 are orientated in the plane direction in the first sheet 51.

Thereafter, as shown in FIG. 2A, the first sheet 51 is disposed at one side in the thickness direction of the release sheet 50 and the wire 2, and subsequently, as shown by an arrow of FIG. 2A, and FIG. 2B, the first sheet 51, the release sheet 50, and the wire 2 are thermally pressed in the thickness direction. In the thermal pressing, for example, a flat plate press is used. Further, for example, the thermal pressing can be also carried out, while interposing a flexible cushion sheet (not shown) at one side (opposite side of the release sheet 50 with respect to the first sheet 51) in the thickness direction of the first sheet 51. Thus, the first sheet 51 is deformed to follow the outer peripheral surface 6 (specifically, the outer peripheral surface 6 except for a thickness directional other end edge 90 in contact (contact at a point) with one surface of the release sheet 50 in a cross-sectional view) of the wire 2.

When the first sheet 51 contains the magnetic particles 60 having a shape having anisotropy (specifically, a generally flat shape), as described above, as shown by the separate frame view of FIG. 2B, the magnetic particles 60 having a shape having anisotropy (specifically, a generally flat shape) are orientated in the circumferential direction of the wire 2 in the above-described region.

Thus, the first layer 10 which is partitioned by the one surface 11, the other surface 12, and the first contact surface 13 is formed.

At this time, the thickness directional other end edge 90 of the wire 2 is still in contact at a point with one surface of the release sheet 50 in a cross-sectional view.

Thereafter, as shown by the arrow and the phantom line of FIG. 2B, the release sheet 50 is peeled from the wire 2 and the first layer 10.

Thus, as shown in FIG. 2C, the other surface 12 of the first layer 10 is exposed toward the other side in the thickness direction. The thickness directional other end edge 90 of the wire 2 is exposed from the other surface 12 of the first layer 10 toward the other side in the thickness direction.

Next, each of the two second sheets 52 is then disposed on one side and the other side in the thickness direction of the first layer 10.

Subsequently, as shown in FIG. 2D, they are thermally pressed. In the thermal pressing, for example, a flat plate press is used.

Thus, the second sheet 52 is deformed to form the second layer 20.

By the thermal pressing described above, the region exposed from the first layer 10 in the outer peripheral surface 6 of the wire 2 is expanded (pushed and expanded) in the first direction, and thus, the one surface 25 of the other-side second layer 22 is brought into contact with the second surface 8 of the wire 2.

Further, at the other side in the thickness direction of the wire 2 and the first layer 10, the second sheet 52 is in contact with the other surface 12 of the first layer 10, while being in contact with the second surface 8 of the outer peripheral surface 6 of the wire 2, and at one side of the first layer 10, the second sheet 52 is in contact with the one surface 11 of the first layer 10. Thus, the second layer 20 is formed on the one surface 11 and the other surface 12 of the first layer 10, find on the second surface 8 of the wire 2.

When the magnetic composition contains a thermosetting component, the magnetic composition is thermally cured by heating at the same time as or after the thermal pressing.

Thus, the magnetic layer 3 embedding the wire 2 is formed.

Thus, the inductor 1 including the wire 2, and the magnetic layer 3 which includes the first layer 10 in contact with the first surface 7 of the wire 2 and the second layer 20 in contact with the second surface 8 of the wire 2 and the surfaces (the one surface 11 and the other surface 12) of the first layer 10 is produced.

Then, in the inductor 1, since the relative magnetic permeability of the first layer 10 is higher than that of the second layer 20, the inductor 1 has excellent DC superposition characteristics.

This is supposedly because the second layer 20 having low relative magnetic permeability is responsible for the role of a core gap.

(Modified Examples)

In the modified examples, the same reference numerals are provided for members and steps corresponding to each of those in one embodiment, and their detailed description is omitted. Also, the modified examples can achieve the same function and effect as that of one embodiment unless otherwise specified. Furthermore, one embodiment and the modified examples thereof can be appropriately used in combination.

The shape of the magnetic particles 60 contained in each of the first layer 10 and the second layer 20 is not limited to the preferred example described above, and both the first layer 10 and the second layer 20 may contain the magnetic particles 60 having a shape showing anisotropy, or may contain the magnetic particles 60 having a shape showing isotropy. Further, each of the first layer 10 and the second layer 20 may contain mixed particles of the magnetic particles 60 having a shape showing anisotropy and the magnetic particles 60 having a shape showing isotropy.

Preferably, as in one embodiment, the first layer 10 contains the anisotropic magnetic particles 60, find the second layer 20 contains the isotropic magnetic particles 60. According to this, it is possible to suppress the magnetic saturation of the magnetic body (the magnetic layer 3) at the time of large current application, and thus, it is possible to ensure excellent DC superposition characteristics.

The contact area S1 of the first layer 10 with respect to the outer peripheral surface 6 (the first surface 7) of the wire 2 may be also smaller than, or the same as the contact area S2 of the second layer 20 with respect to the outer peripheral surface 6 (the second surface 8) of the wire 2.

Preferably, as in one embodiment, the contact area S1 of the first layer 10 with respect to the outer peripheral surface 6 (the first surface 7) of the wire 2 is larger than the contact area S2 of the second layer 20 with respect to the outer peripheral surface 6 (the second surface 8) of the wire 2. According to one embodiment, it is possible to suppress the magnetic saturation of the magnetic body (the magnetic layer 3) at the time of large current application, and thus, it is possible to ensure excellent DC superposition characteristics.

In one embodiment, the first layer 10 has the arc portion 15. Alternatively, for example, though not shown, the first layer 10 may be configured without having the arc portion 15.

Further, in the second layer 20, both the one surface 23 of the one-side second layer 21 and the other surface 26 of the other-side second layer 22 are flat surfaces. Alternatively, both or one of these may include an arc surface corresponding to the wire 2.

Preferably, as in one embodiment, the first layer 10 has the arc portion 15, and both the one surface 23 of the one-side second layer 21 and the other surface 26 of the other-side second layer 22 are flat surfaces.

In one embodiment, since it is possible to ensure a high inductance value by the arc portion 15, the second layer 20 can be made thinner, while excellent DC superposition characteristics are ensured. As a result, the inductor 1 has excellent DC superposition characteristics, while being thin.

In one embodiment, the extending portion 16 extends from the circumferential surface of the wire 2 to reach the end surface in the first direction of the inductor 1. Alternatively, for example, though not shown, the extending portion 16 can also extend to an intermediate portion between the circumferential surface of the wire 2 and the end surface in the first direction of the inductor 1 without reaching the end surface in the first direction of the inductor 1 from the circumferential surface of the wire 2.

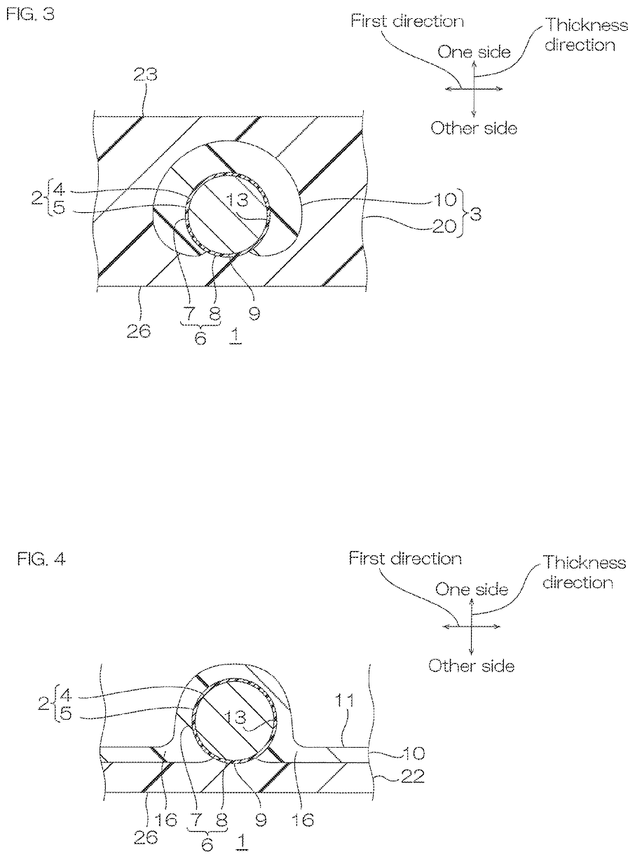

In one embodiment, the first layer 10 includes the extending portion 16. Alternatively, for example, as shown in FIG. 3, the first layer 10 may also not include the extending portion 16.

Preferably, the first layer 10 includes the extending portion 16. Thus, it is possible to ensure a high inductance value and excellent superposition characteristics.

In one embodiment, the magnetic layer 3 includes the first layer 10 and the second layer 20. Alternatively, for example, as shown by the phantom line of FIG. 2D, the magnetic layer 3 may also further include a third layer 30.

The third layer 30 is disposed on the surface of the second layer 20.

The third layer 30 includes a one-side third layer 31 and an other-side third layer 32. The one-side third layer 31 is disposed on the one surface 23 of the one-side second layer 21. The other-side third layer 32 is disposed on the other surface 26 of the other-side second layer 22.

The relative magnetic permeability of the third layer 30 is not particularly limited, and is, for example, the same as or not more than the relative magnetic permeability of the first laser 10, and is also, for example, not less than the relative magnetic permeability of the second layer 20. The relative magnetic permeability of the third layer 30 is preferably an average value or more of the relative magnetic permeability of the first layer 10 and the relative magnetic permeability of the second layer 20, and is more preferably the same as the relative magnetic permeability of the first layer 10.

To form the magnetic layer 3 having the third layer 30, a third sheet 53 is disposed outside the second sheet 52. Specifically, each of the two third sheets 53 is disposed outside each of the two second sheets 52. Thereafter, they are thermally pressed. Thus, the third layer 30 is formed from the third sheet 53.

Also, the third layer 30 may include only one of the one-side third layer 31 and the other-side third layer 32.

Also, as shown in FIG. 4, the second layer 20 may include only the other-side second layer 22 without having the one-side second layer 21. In this case, the one surface 11 of the first layer 10 is exposed toward one side in the thickness direction.

Further, though not shown, when a plurality of layers in which the relative magnetic permeability is discontinuously reduced toward one side of the first layer 10 are disposed, only the layer in contact with the one surface 11 of the first layer 10 is the second layer 20 (the one-side second layer 21). Further, when a plurality of layers in which the relative magnetic permeability is discontinuously reduced toward the other side of the first layer 10 are disposed, only the layer in contact with the other surface 12 of the first layer 10 is the second layer 20 (the other-side second layer 22).

In one embodiment, the wire 2 has a generally circular shape in a cross-sectional view. However, the shape thereof in a cross-sectional view is not particularly limited, and though not shown, examples of the shape thereof may include a generally elliptical shape, a generally rectangular (including square and rectangular) shape, and a generally indefinite shape. As an embodiment in which the wire 2 includes a generally rectangular shape, at least one side may be curved, and also, at least one corner may be curved.

### EXAMPLES

Next, the present invention is further described based on Examples and Comparative Example below. The present invention is however not limited by these Examples and Comparative Example. The specific numerical values in mixing ratio (content ratio), property value, and parameter used in the following description can be replaced with upper limit values (numerical values defined as “or less” or “below”) or lower limit values (numerical values defined as “or more” or “above”) of corresponding numerical values in mixing ratio (content ratio), property value, and parameter described in the above-described “DESCRIPTION OF EMBODIMENTS”.

### Preparation Example 1

<Preparation of Binder>

A binder was prepared in accordance with the formulation described in Table 1.

### Example 1

<Production Example of Inductor Based on One Embodiment>

As shown in FIG. 2A, first, the wire 2 having a radius of 130 μm was prepared. A radius of the conducting line 4 was 115 μm, and a thickness of the insulating film 5 was 15 μm.

Next, the wire 2 was disposed on one surface of the release sheet 50.

Then, the first sheet 5 and the second sheet 52 were fabricated from a magnetic composition containing the magnetic particles 60 and a binder of Preparation Example 1 so as to have the kind and the filling ratio of the magnetic particles 60 described in Table 2.

Further, the five first sheets 51 having a thickness of 60 μm and the relative magnetic permeability of 140 were prepared.

The 10 second sheets 52 having a thickness of 57 μm and the relative magnetic permeability of 7.9 were prepared.

Thereafter, as shown in FIG. 2A, the five first sheets 51 were disposal at one side in the thickness direction of the wire 2 and the release sheet 50, and subsequently, as shown in FIG. 2B, they were thermally pressed using a flat plate press, thereby forming the first layer 10.

Subsequently, as shown by the phantom line of FIG. 2B, the release sheet 50 was peeled front the wire 2 and the first layer 10, and subsequently, as shown in FIG. 2C, the five second sheets 52, the wire 2, the first layer 10, and the five second sheets 52 were disposed in order.

Thereafter, they were thermally pressed using a flat plate press to form the second layer 20.

Thus, the inductor 1 including the wire 2, and the magnetic layer 3 having the first layer 10 and the second layer 20 was produced. A thickness of the inductor 1 was 430 μm.

### Example 2 to Comparative Example 1

The inductor 1 was produced in the same manner as in Example 1, except that the formulation of the magnetic sheet was changed in accordance with Tables 3 to 6.

In the inductor 1 of Example 3, the magnetic layer 3 included the third layer 30 having the one-side third layer 31 and the other-side third layer 32.

In the inductor 1 of Example 4, the magnetic layer 3 included the third layer 30 having only the other-side third layer 32 without having the one-side third layer 31.

Further, the inductor 1 of Comparative Example 1 included the single magnetic layer 3 having the relative magnetic permeability of 140.

<Evaluation>

The following items are evaluated, and the results are described in Tables 2 to 7.

<Relative Magnetic Permeability>

The relative magnetic permeability of each of the first sheets 51 of Example 1 to Comparative Example 1, each of the second sheets 52 of Examples 1 to 4, and each of the third sheets 53 of Examples 3 to 4 was measured with an impedance analyzer (manufactured by Agilent Technologies Japan, Ltd.: “4291B”) using a magnetic material test fixture.

<DC Superposition Characteristics>

The DC superposition characteristics were evaluated by measuring a reduction ratio of inductance by flowing an electric current of 10A to the conducting line 4 of the inductor 1 of Example 1 to Comparative Example 1 using an impedance analyzer (manufactured by Kuwaki Electronics, Co., Ltd., “65120B”) installed with a DC bias test fixture and a DC bias power supply.

The reduction ratio of inductance was calculated based on the following formula.

[Inductance in a state where no DC bias current ts applied-Inductance in a state where DC bias current is applied]/[Inductance in a state where DC bias current is applied]×100 (%)

TABLE 1

| Formulation of Binder | | | Preparation Ex. 1 |
|---|---|---|---|
| Thermoplastic | Carboxyl Group-Containing | TEISANRESIN SG-70LN | 18.7 |
| Component | Aerylic Acid Ester Copolymer | Manufactured by Nagase | |
| | | ChemteX Corporation | |
| Thermosetting | Cresol Novolak-type Epoxy | EPICLON N-665-EXP-S | 9.7 |
| Component (Epoxy | Resin (Main Agent) | Manufactured by DIC | |
| Resin Composition) | | Corporation | |
| | Phenol Resin (Curing Agent) | MEHC-7851SS | |
| | | Manufactured by MEIWA | 9.7 |
| | | PLASTIC INDUSTRIES LTD. | |
| | Imidazole Compound | 2PHZ-PW | 0.3 |
| | (Curing Accelerator) | Manufactured by SHIKOKU | |
| | | CHEMICALS CORPORATION | |

Numerical Value: % by volume

TABLE 2

| | | Magnetic Layer | | | Magnetic Particles | | | | Number of | | |
|---|---|---|---|---|---|---|---|---|---|---|---|
| | | | Thickness | Reduction | | Neutral | | Filling | Magnetic | | |
| | | Relative | of Each | Ratio of | | Particle | | Ratio | Sheet | | |
| | | Magnetic | Magnetic | Inductance | | Size | | (% by | Used for | | |
| Ex. 1 | | Permeability | Sheet (μm) | (%) | Shape | [μm] | Kind | volume) | Production | R(ratio)*^{A} | D(%)*^{B} |
| Magnetic | First | 140 | 85 | 33.5 | Flat | 40 | Sendust | 60 | 5 | 17.7 | 132 |
| Sheet | Sheet | | | | | | | | | | |

| | | | | | | | | | | |
|---|---|---|---|---|---|---|---|---|---|---|
| Second | 7.9 | 60 | Spherical | 1.5 | Carbonyl | 57 | 10 | One | 5 | — |
| Sheet | | | | | Iron | | | Side | | |
| | | | | | Powder | | | Other | 5 | |
| | | | | | | | | Side | | |

*^{A}R = Relative Magnetic Permeability of First Sheet/Relative Magnetic Permeability of Second Sheet
*^{B}D = Relative Magnetic Permeability of First Sheet − Relative Magnetic Permeability of Second Sheet

TABLE 3

| | | Magnetic Layer | | | Magnetic Particles | | | | Number of | | |
|---|---|---|---|---|---|---|---|---|---|---|---|
| | | | Thickness | Reduction | | Neutral | | Filling | Magnetic | | |
| | | Relative | of Each | Ratio of | | Particle | | Ratio | Sheet | | |
| | | Magnetic | Magnetic | Inductance | | Size | | (% by | Used for | | |
| Ex. 2 | | Permeability | Sheet (μm) | (%) | Shape | [μm] | Kind | volume) | Production | R(ratio)*^{A} | D(%)*^{B} |
| Magnetic | First | 140 | 85 | 45.5 | Flat | 40 | Sendust | 60 | 7 | 17.7 | 132 |
| Sheet | Sheet | | | | | | | | | | |

| | | | | | | | | | | |
|---|---|---|---|---|---|---|---|---|---|---|
| Second | 7.9 | 60 | Spherical | 1.5 | Carbonyl | 57 | 10 | One | 6 | — |
| Sheet | | | | | Iron | | | Side | | |
| | | | | | Powder | | | Other | 4 | |
| | | | | | | | | Side | | |

*^{A}R = Relative Magnetic Permeability of First Sheet/Relative Magnetic Permeability of Second Sheet
*^{B}D = Relative Magnetic Permeability of First Sheet − Relative Magnetic Permeability of Second Sheet

TABLE 4

| | | Magnetic Layer | | | Magnetic Particles | | | | | | | | | | |
|---|---|---|---|---|---|---|---|---|---|---|---|---|---|---|---|
| | | | Thickness | Reduction | | Neutral | | Filling | Number of | | | | | | |
| | | Relative | of Each | Ratio of | | Particle | | Ratio | Magnetic | | | | | | |
| | | Magnetic | Magnetic | Inductance | | Size | | (% by | Sheet Used | | | | | | |
| Ex. 3 | | Permeability | Sheet (μm) | (%) | Shape | [μm] | Kind | volume) | for Production | | | R(ratio)*^{A} | | D(%)*^{B} | |
| Magnetic | First | 140 | 85 | 40.1 | Flat | 40 | Sendust | 60 | 5 | | | R1 | 17.72 | D1 | 132 |
| Sheet | Sheet | | | | | | | | | | | | | | |
| | Second | 7.9 | 60 | | Spherical | 1.5 | Carbonyl | 57 | 10 | One Side | 5 | R2 | 0.12 | D2 | −59 |
| | Sheet | | | | | | Iron | | | Other Side | 5 | | | | |
| | | | | | | | Powder | | | | | | | | |
| | Third | 66.6 | 60 | | Flat | 60 | Fe—Si | 49 | 4 | One Side | 2 | — | | | |
| | Sheet | | | | | | Alloy | | | Other Side | 2 | | | | |

*^{A}R1 = Relative Magnetic Permeability of First Sheet/Relative Magnetic Permeability of Second Sheet
R2 = Relative Magnetic Permeability of Second Sheet/Relative Magnetic Permeability of Third Sheet
*^{B}D1 = Relative Magnetic Permeability of First Sheet − Relative Magnetic Permeability of Second Sheet
D2 = Relative Magnetic Permeability of Second Sheet − Relative Magnetic Permeability of Third Sheet

TABLE 5

| | | Magnetic Layer | | | Magnetic Particles | | | | | | | | | | |
|---|---|---|---|---|---|---|---|---|---|---|---|---|---|---|---|
| | | | Thickness | Reduction | | Neutral | | Filling | Number of | | | | | | |
| | | Relative | of Each | Ratio of | | Particle | | Ratio | Magnetic | | | | | | |
| | | Magnetic | Magnetic | Inductance | | Size | | (% by | Sheet Used | | | | | | |
| Ex. 4 | | Permeability | Sheet (μm) | (%) | Shape | [μm] | Kind | volume) | for Production | | | R(ratio)*^{A} | | D(%)*^{B} | |
| Magnetic | First | 140 | 85 | 71.5 | Flat | 40 | Sendust | 60 | 7 | | | R1 | 17.7 | D1 | −132 |
| Sheet | Sheet | | | | | | | | | | | | | | |
| | Second | 7.9 | 60 | | Spherical | 1.5 | Carbonyl | 57 | 10 | One Side | 6 | R2 | 0.06 | D2 | 132 |
| | Sheet | | | | | | Iron | | | Other Side | 4 | | | | |
| | | | | | | | Powder | | | | | | | | |
| | Third | 140 | 85 | | Flat | 40 | Sendust | 60 | 2 | One Side | — | — | | | |
| | Sheet | | | | | | | | | Other Side | 2 | | | | |

*^{A}R1 = Relative Magnetic Permeability of First Sheet/Relative Magnetic Permeability of Second Sheet
R2 = Relative Magnetic Permeability of Second Sheet/Relative Magnetic Permeability of Third Sheet
*^{B}D1 = Relative Magnetic Permeability of Second Sheet − Relative Magnetic Permeability of First Sheet
D2 = Relative Magnetic Permeability of Third Sheet − Relative Magnetic Permeability of Second Sheet

TABLE 6

| | Magnetic Layer | | | | | | | | | |
|---|---|---|---|---|---|---|---|---|---|---|
| | | Thickness | | Magnetic Particles | | | | Number | | |
| | Relative | of Each | Reduction | | Neutral | | Filling | of Magnetic | | |
| Com- | Magnetic | Magnetic | Ratio of | | Particle | | Ratio | Sheet Used | | |
| parative | Perm- | Sheet | Inductance | | Size | | (% by | for Pro- | | |
| Ex. 1 | eability | (μm) | (%) | Shape | [μm] | Kind | volume) | duction | | |
| Magnetic | 140 | 85 | 78.5 | Flat | 40 | Sendust | 60 | 7 | One | 3 |
| Sheet | | | | | | | | | Side | |
| | | | | | | | | | Other | 4 |
| | | | | | | | | | Side | |

TABLE 7

| | | | | | | | Comparative |
|---|---|---|---|---|---|---|---|
| Ex. Comparative Ex. | | | Ex. 1 | Ex. 2 | Ex. 3 | Ex. 4 | Ex. 1 |
| Embodiment | | | One | One | Modified | Modified | — |
| | | | Embodiment | Embodiment | Example | Example | |
| Thickness | Inductor | | 430 | 570 | 620 | 610 | 500 |
| (μm) | First Layer | | 90 | 130 | 90 | 130 | 500 |
| | Second | One-Side | 20 | 60 | 20 | 60 | — |
| | | Second | | | | | |
| | | Layer | | | | | |
| | Layer | Other-Side | 60 | 120 | 60 | 120 | — |
| | | Second | | | | | |
| | | Layer | | | | | |

| | | | | | | |
|---|---|---|---|---|---|---|
| Relative | First Sheet | 140 | 140 | 140 | 140 | 140.0 |
| Magnetic | Second Sheet | 7.9 | 7.9 | 7.9 | 7.9 | |
| Permeability | Third Sheet | — | — | 66.6*¹ | 140*² | |
| DC | Reduction Ratio*⁰ | 33.5 | 45.5 | 40.1 | 71.5 | 78.5 |
| Superposition | of Inductance (%) | | | | | |
| Characteristics | | | | | | |

*¹One-side second sheet and other-side second sheet
*²Only other-side second sheet

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

### INDUSTRIAL APPLICABILITY

The inductor of the present invention is, for example, loaded on an electronic device and the like.

### DESCRIPTION OF REFERENCE NUMERALS

1 Inductor

2 Wire

3 Magnetic layer

4 Conducting line

5 Insulating film

10 First layer

16 Extending portion

20 Second layer

23 One surface (one example of flat surface)

26 Other surface (one example of flat surface)

60 Magnetic particles

S1 Contact area of first layer

S2 Contact area of second layer

1. An inductor comprising:
a wire including a conducting line, and an insulating film disposed on an entire circumferential surface of the conducting line, and
a magnetic layer embedding the wire, wherein
the magnetic layer contains a magnetic particle, and includes a first layer in contact with a portion of the circumferential surface of the wire, and a second layer in contact with the rest of the circumferential surface of the wife and the surface of the first layer, and
the relative magnetic permeability of the first layer is higher than the relative magnetic permeability of the second layer.

2. The inductor according to claim 1, wherein
the magnetic particle contained in the first layer has a generally flat shape, and
the magnetic particle contained in the second layer has a generally spherical shape.

3. The inductor according to claim 1, wherein
the contact area S1 of the first layer with respect to the circumferential surface of the wire is larger than the contact area S2 of the second layer with respect to the circumferential surface of the wire.

4. The inductor according to claim 3, wherein
a ratio (S2/(S1+S2)) of the contact area S2 of the second layer to the total sum of the contact area S1 of the first layer and the contact area S2 of the second layer is 0.1 or more, and 0.3 or less.

5. The inductor according to claim 1, wherein
the first layer has a generally arc shape in a cross-sectional view sharing the center of gravity with the wire, and the second layer has a flat surface.

6. The inductor according to claim 1, wherein
the first layer has an extending portion extending from the wire in a direction perpendicular to an extending direction of the wire find a thickness direction of the magnetic layer.
